(19) United States
(12) Patent Application Publication
(10) Pub. No.: US 2015/0137959 A1
(43) Pub. Date: May 21, 2015

(54) DISPLAY APPARATUS AND METHOD OF SETTING A UNIVERSAL REMOTE CONTROLLER

(71) Applicant: SAMSUNG ELECTRONICS CO., LTD., Suwon-si (KR)

(72) Inventors: Kwan-young KIM, Suwon-si (KR); Moon-sung NA, Suwon-si (KR); Min-sup KIM, Suwon-si (KR); Hyun-kyu YUN, Seoul (KR)

(73) Assignee: SAMSUNG ELECTRONICS CO., LTD., Suwon-si (KR)

(21) Appl. No.: 14/261,662

(22) Filed: Apr. 25, 2014

(30) Foreign Application Priority Data
Nov. 15, 2013 (KR) 10-2013-0139055

(51) Int. Cl. G08C 17/02

(52) U.S. Cl. CPC G08C 17/02; G08C 2201/92
USPC 340/12.28

(57) ABSTRACT

A display apparatus and a universal remote controller setting method are provided. According to the display apparatus, a display is provided which is configured to display contents received from a broadcast channel, a communicator configured to communicate with a server which stores a control code set according to a plurality of broadcaster, and a controller configured to extract feature information related to contents and transmits feature information and broadcast channel number information to the server through a communicator, is included. The controller is configured to provide the control code set to a universal remote controller in response to a control code set which corresponds to feature information and broadcast channel number information being received from the server.

### CROSS-REFERENCE TO RELATED APPLICATION

This application claims priority from Korean Patent Application No. 10-2013-0139055, filed on Nov. 15, 2013, in the Korean Intellectual Property Office, the disclosure of which is incorporated herein by reference, in its entirety.

### BACKGROUND

1. Technical Field

Methods and apparatuses consistent with the exemplary embodiments relate to a display apparatus and a method of setting a universal remote controller. More particularly, the exemplary embodiments relate to a display apparatus and a method of setting a universal remote controller which allows a user to more conveniently set a control code set of a universal remote controller.

2. Description of the Related Art

With the development of electronic technology and communication technology, various kinds of electronic apparatuses have been developed and distributed, and it is commonly known that each household or each company has a plurality of various electronic apparatuses.

It is commonly known that when a user uses an electronic apparatus, a remote controller is often used for the user to conveniently control the electronic apparatus.

However, as the number of electronic apparatuses used in each household and each company increases, the number of remote controllers also increases. Accordingly, the use of a universal remote controller for effectively controlling a plurality of electronic apparatuses increases.

However, to set a universal remote controller, a user needs to register information related to an electronic apparatus. More particularly, the user needs to know a manufacturer of the electronic apparatus and model information. Even if the user can easily know the manufacturer of the electronic apparatus and the model information, the user needs to know a control code set related to an apparatus that the user wishes to control in order to set the universal remote controller. However, since there are various manufacturers of a universal remote controller or a display apparatus, and the types of apparatus models are increasing, it is not easy for the user to set a control code set to the universal remote controller.

Therefore, a method of more conveniently setting the universal remote controller is required.

### SUMMARY

The exemplary embodiments have been made to address at least the above problems and an aspect of the exemplary embodiments provides a display apparatus and a method of setting a universal remote controller which more conveniently sets a control code set of a universal remote controller.

A display apparatus according to an exemplary embodiment includes a display configured to display contents received from a broadcast channel, a communicator configured to perform communication with a server which stores a control code set according to a plurality of broadcast providers, and a controller configured to extract feature information related to the contents and broadcast channel number information, and transmits the information to the server through the communicator, and in response to a control code set of a broadcast provider corresponding to the feature information and the broadcast channel number information being received from the server, provides the control code set to a universal remote controller.

The display apparatus may further include a storage configured to store matching information between the broadcast channel number information and the feature information related to the contents, wherein the controller, in response to a predetermined number of matching information being stored, is configured to transmit to the server the matching information stored in the storage.

The server may be implemented within the display apparatus.

The controller may be configured to display a User Interface (UI) for registering the control code set in the universal remote controller on the display in response to the control code set being received from the server.

The control code set may include button information regarding each button included in the universal remote controller and signal information which occurs in response to the button being selected.

The feature information may include a broadcast company logo displayed on a content screen, wherein the controller detects an image of an area where the broadcast company logo is displayed from the content screen, and recognizes the broadcast company logo in the image.

The feature information of the contents may include at least one of a broadcast company logo, a broadcast company name, a program logo, an image of characters, a channel banner and a text displayed on a content screen.

A method of setting a universal remote controller of a display apparatus according to an exemplary embodiment may include displaying contents received from a broadcast channel, extracting the feature information of contents and the broadcast channel number information, transmitting the feature information and broadcast channel number information to a server which stores a control code set according to the plurality of broadcast providers, and providing the control code set to a universal remote controller broadcast in response to a control code set which corresponds to the feature information and channel information being received from the server.

The transmitting of the feature information and broadcast channel number information may include storing matching information between the broadcast channel number information and the feature information of the contents, and sending the stored matching information to the server in response to the predetermined number of matching information being stored.

The server may be implemented within the display apparatus.

Providing the control code set to a universal remote controller may further include displaying UI for registering the control code set in the universal remote controller in response to the control code set being received from the server.

The control code set may include button information regarding each button included in the universal remote controller and signal information which occurs in response to a button being selected.

The feature information may include a broadcast company logo displayed on the contents screen, and extracting the feature information may include detecting an image on an area where the broadcast company logo is displayed from the contents screen and recognizing the broadcast company logo on the image.

The feature information of the contents may include one of a broadcast company logo, a broadcast company name, a program logo, an image of characters, a channel banner and a text displayed on a content screen.

An aspect of an exemplary embodiment may provide a display apparatus including: a controller configured to extract feature information received from a broadcast channel which is related to contents and broadcast channel number information, and transmit the information to a server through a communicator and provide a control code set to a universal remote controller in response to a control code set of a broadcast provider corresponding to the received feature information and the broadcast channel number information.

The control code set may include button information regarding each button included in the universal remote controller and signal information which occurs in response to each button being selected.

The display apparatus may further include a communicator configured to perform communication with a server which is configured to store a control code set according to a plurality of broadcast providers.

The display apparatus may further include: a storage configured to store matching information between the broadcast channel number information and the feature information related to the contents.

The display apparatus may be configured to transmit the matching information stored in the storage to the server in response to a predetermined number of matching information being stored.

The server may be implemented within the display apparatus.

According to various aspects of an exemplary embodiment, the user may conveniently set a universal remote controller through a display apparatus.

### BRIEF DESCRIPTION OF THE DRAWINGS

FIG. 1. is a block diagram which illustrates a configuration of a display apparatus according to an exemplary embodiment:

FIG. 2. is a block diagram which illustrates a configuration of a display apparatus in detail according to an exemplary embodiment;

FIG. 3. is a diagram which illustrates a method of setting a universal remote controller according to an exemplary embodiment;

FIG. 4. is a diagram which illustrates an exemplary embodiment which extracts feature information of contents and broadcast channel number information;

FIGS. 5 to 8 are diagrams which illustrate a channel map according to an exemplary embodiment; and

FIGS. 9 to 10 are flowcharts to explain a method of setting a universal remote controller.

### DETAILED DESCRIPTION OF THE EXEMPLARY EMBODIMENTS

Hereinafter, exemplary embodiments will be described in greater detail with reference to the accompanying drawings. In explaining the exemplary embodiments, in response to it appearing that a detailed explanation regarding a related art or configuration obscures a an item of substance of the exemplary embodiments with unnecessary detail, the detailed explanation may be omitted. Terms used below are justified in accordance with a function of the exemplary embodiments, and these may change according to an intention of a user and an operator, and custom in the art. Therefore, the justification should be made through the overall specification of the exemplary embodiments.

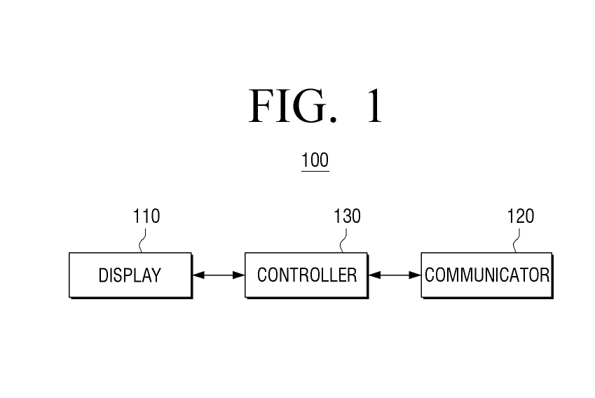

FIG. 1 is a block diagram which illustrates a configuration of a display apparatus 100 according to an exemplary embodiment. According to FIG. 1, the display apparatus 100 includes a display 110, a communicator 120 and a controller 130. The display apparatus 100 may be a TV, but it may be various kinds of electronic apparatuses with a display such as a tablet PC, a camcorder, a notebook PC, a PDA, a TV and so on.

The display 110 is a component to display an image. The display 110 may display contents received from a broadcast channel. That is, the display apparatus 100 may receive various kinds of broadcast signals that a broadcast company transmits through a Radio Frequency (RF) network, and also may receive contents from various kinds of servers through IP network, and the display 110 may display the received contents.

The communicator 120 performs communication with various kinds of external apparatuses according to various types of communication methods. In particular, the communicator 120 may communicate with a server which stores a control code set which corresponds to a various broadcast. That is, the communicator 120 may transmit extracted feature information and broadcast channel information to the server, and receive the code set from the server.

The server may be, but is not limited to, an independent server which is provided separately from the display apparatus 100. The server may also be implemented within the display apparatus 100.

The communicator 120 may include various kinds of communication chips such as a Wi-Fi chip, a Bluetooth® chip, an NFC (Near Field Communication) chip, a wireless communication chip and so on. The Wi-Fi chip, the Bluetooth® chip, and the NFC chip may execute communications according to a Wi-Fi communication method, a Bluetooth® communication method, and an NFC communication method, respectively. The NFC chip refers to a chip executed through the NFC method which uses 13.56 MHz band among various RF-ID frequency such as 135 kHz, 13.56 MHz, 433 MHz, 860-960 MHz, 2.45 GHz, and so on. In a case of using the Wi-Fi chip or the Bluetooth® chip, the communicator may transmit and receive various kinds of connecting information such as SSID and a session key, and after connecting communication, the communicator may transmit and receive various kinds of information. The wireless communication chip refers to a chip which executes a communication according to various communication standards, such as IEEE, Zigbee®, 3rd Generation (3G), 3rd Generation Partnership Project (3GPP), Long Term Evolution (LTE) and so on.

The controller 130 controls overall operations of the display apparatus 100. In particular, the controller 130 may extract feature information and broadcast channel number information related to contents. The controller 130 may control the communicator 120 to transmit to the server extracted feature information and the broadcast channel number information.

The controller 130 may provide a control code set to a universal remote controller in response to the control code set of a broadcaster corresponding to the feature information and the broadcast channel number information being received from the server.

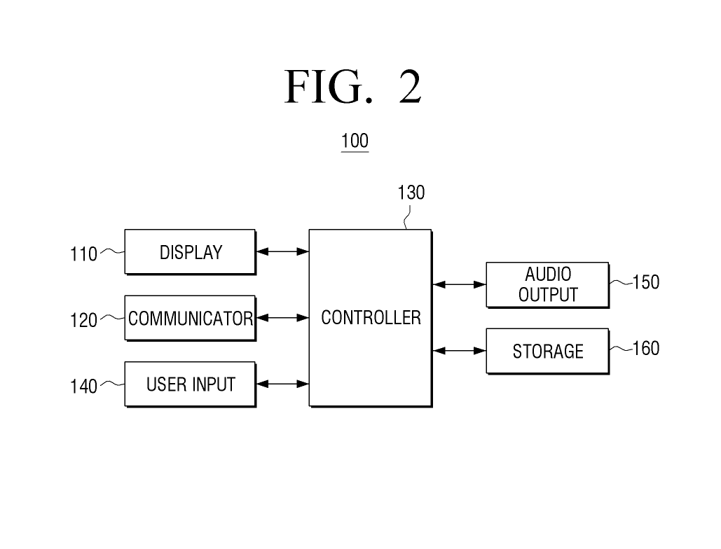

The controller 130 may transmit the stored matching information to the server in response to more than a certain number of matching information which matches to the feature information and the broadcast channel number information being stored. FIG. 2 is a block diagram which illustrates a configuration of the display apparatus according to an exemplary embodiment.

According to FIG. 2, the display apparatus 100 may include the display 110, the communicator 120, the controller 130, a user input 140, an audio output 150, and a storage 160. FIG. 2 comprehensively illustrates various kinds of components, with examples of the display apparatus 100 equipped with various functions such as a universal remote controller function, a communication function, a video playback function, a display function, and so on. According to an exemplary embodiment, a part of the components in FIG. 2 may be deleted or changed, and another component or components may be added.

Among components of FIG. 2, the components which are the same as the components illustrated in FIG. 1 will not be described.

The user input 140 is a component to input a user's command to control the display apparatus 100. The user input 140 may receive the user's command which is input through a button equipped in a main body of the display apparatus 100 or a button equipped in a remote controller, and transmit the user's command to the controller 130.

The audio output 150 may output audio data. An audio processor (not illustrated) of the display apparatus 100 performs an audio data process, and various processes may be performed such as decoding, amplification and noise filtering of the audio data. Therefore, the audio output 150 may output the audio data processed from the audio processor (not illustrated).

The storage 160 is a component which stores various software modules and data to drive the display apparatus 100. For example, the storage 160 may save software including a base module, a sensing module, a communication module, a presentation module, a web browser module and a service module.

The communication module stored in the storage 160 is performed by the controller 130, and the communication module is a software module which is to communicate with an external apparatus such as a server or a universal remote controller, and so on. The storage 160 may store an application to extract feature information from contents, an application to extract broadcast channel number information, and a managing program to match the extracted information and to save or store the extracted information.

The controller 130, by using various kinds of software stored in the storage 160, may perform a setting operation regarding a universal remote controller, as described above.

Specifically, the controller 130 may match this information mutually, and store this matching information to the storage 160 in response to the broadcast channel number information and feature information of contents being respectively extracted,.

The broadcast channel number is a channel number of a broadcast that the display 110 displays, and the feature information of contents means a broadcast company name, a program name, a program logo, an image of characters, a channel banner, a text and so on, which are displayed on a content screen. The feature information of contents refers to all information to determine a broadcast company which transmits a corresponding content.

Specifically, the feature information may be a broadcast company logo displayed in a content screen, and the controller 130 may detect an image of an area where the broadcast company logo is displayed from the content screen, and recognize the broadcast logo inside of the image.

A detailed method to extract the feature information is described below.

The controller 130 may analyze contents displayed in the display 110 and extract the broadcast channel information and the feature information of the contents. The controller 130 may match the extracted information and store the extracted information in the storage 160.

In response to the controller 130 determining that a universal remote controller is ready to be set because a predetermined number of matching information is stored in the storage 160, the controller 130 transmits the matching information to a server 200. Thereafter, the controller 130 may receive a control code set of a broadcaster which corresponds to the matching information. A limiting number of the matching information may change according to a default value, or a user's setting.

The controller 130 may determine whether the control code set which corresponds to the matching information can be received by transmitting the matching information stored in the storage 160 to the server 200 at a predetermined interval of time.

The controller 130 may display a User Interface (UI) 300 for registering the control code set in a universal remote controller on the display 110 in response to the control code set being received from the server 200.

Specifically, in response to a determination that the universal remote controller is ready to be set because the control code set is received from the server 200, the controller 130 may confirm to the user whether the received control code set for setting the universal remote controller is correct, or display the UI which notifies a receipt of the control code set and setting of the universal remote controller.

Herein, the control code set may include button information regarding each button included in the universal remote controller and signal information which occurs in response to each button being selected.

A remote controller to control the display apparatus 100 is different according to a broadcaster or a manufacturer of the display apparatus 100, and each button of each remote controller may have a different output signal. Accordingly, the server 200 may store an output signal according to each button of each remote controller as a control code set, according to a broadcaster or a manufacturer. Also, the server 200 may frequently update the control code set.

Through the display apparatus described above, without a separate setting of a universal remote controller, a user may automatically set and use the universal remote controller.

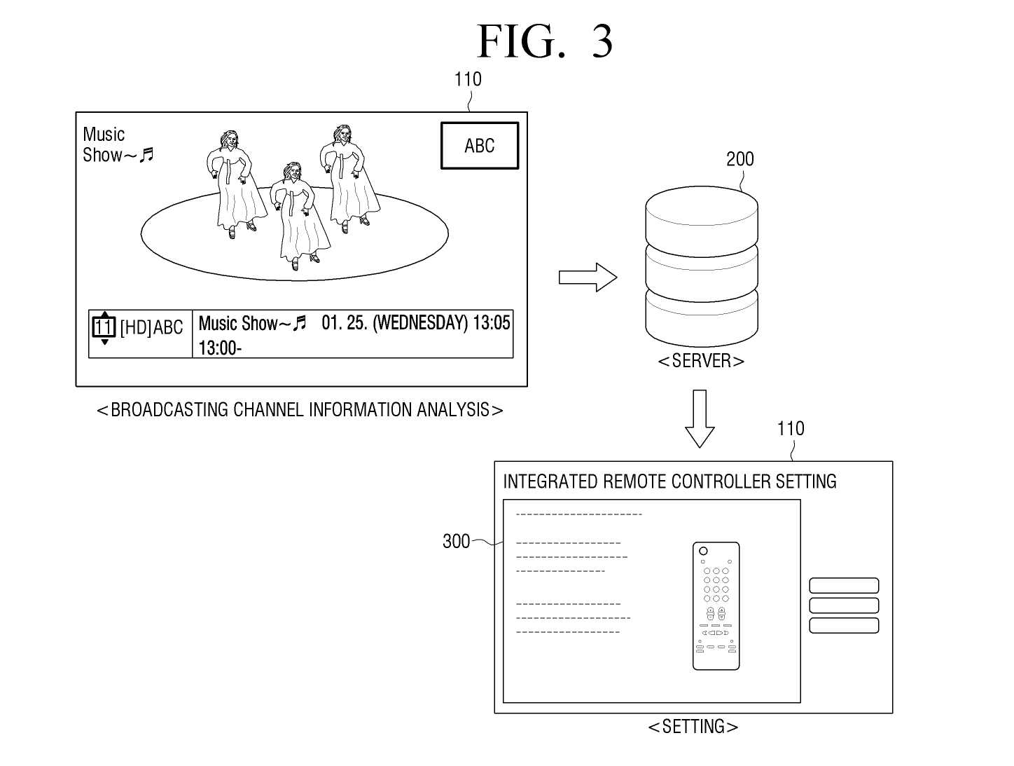

FIG. 3 is a diagram provided to explain, in detail, a process of setting a universal remote controller.

In response to a user using the display apparatus 100 which does not finish a setting of a universal remote controller, the user may control the display apparatus 100 with a remote controller offered by a manufacturer of the display apparatus 100 or a broadcaster. That is, the user may change a broadcast channel through the remote controller supplied by the broadcaster or manufacturer before setting the universal remote controller.

In response to a broadcast channel being changed and resulting in a displayed content being changed, the controller 130 may extract the feature information of the content and the broadcast channel number information.

Specifically, as illustrated in FIG. 3, the controller 130 may determine that a broadcast channel number of a displayed content is 11 by extracting broadcast channel number information. Also, since the content received from a normal broadcast channel includes a broadcast company logo, the controller 130 may extract information that the broadcast company logo is ABC.

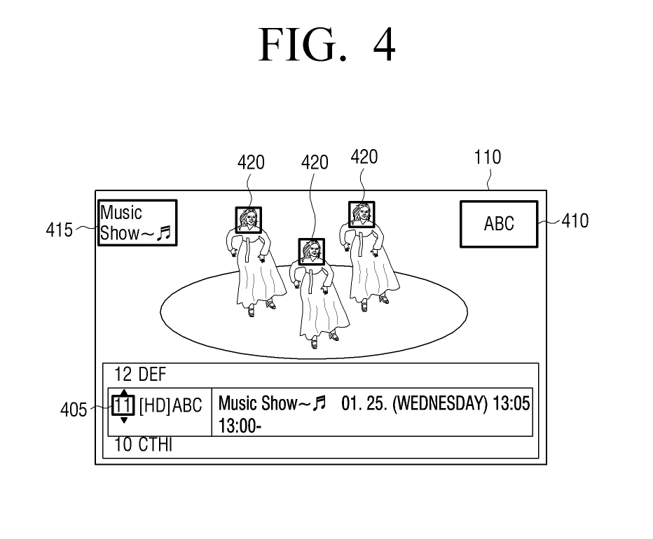

The feature information may include not only a broadcast company logo, but also a broadcast company name, a program name, a program logo, an image of characters, a channel banner, and a text. For example, as described in FIG. 4, the feature information may be a name of a content 415, or a character 420 appearing in the content.

A method for extracting the feature information of the controller 130 may be performed using various methods of image analysis. For example, the controller 130 classifies a displayed content screen into a plurality of blocks by dividing it in the direction of width and height. One block may be composed of a plurality of pixels. The controller 130, after detecting a characteristic value of the pixel included in the each block, determines whether the block is composed with an identical characteristic value by comparing a characteristic value of the block with surrounding blocks.

The controller 130 performs this determination process on the each block, and extracts edge part of each block. The controller 130, taking into account a color, a shape, and a size of each part according to the edge part, detects a coordinate of a user's face area, eyeball area, and iris area gradually in response to the feature information relating to a person. In response to the feature information being a letter including a number, a color, a shape, and a size of each area are took into account. In this detecting process, various algorithms and models may be applied. Since various documents regarding this were announced, further detailed explanation is omitted.

The controller 130 may store matching information which matches the broadcast channel number information and the feature information of contents mutually, or immediately transmit the information to the server 200. That is, the controller 130 may transmit to the server 200 after storing the matching information as a predetermined number in the storage 160, or transmit to the server 200 immediately after detecting the matching information.

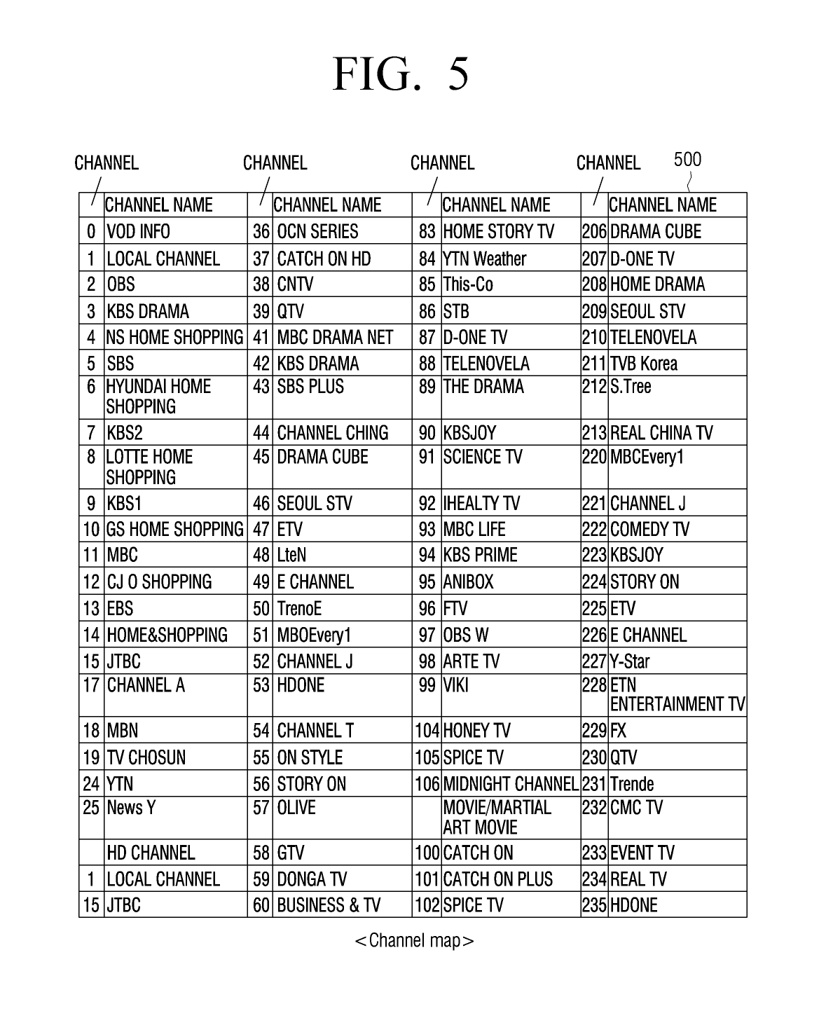

The server 200 may store a channel map illustrated in FIG. 5. The display apparatus 100 has different broadcast companies which provide broadcast contents to each channel number according to a broadcaster or a manufacturer. Accordingly, the channel map is a diagram which shows what broadcast content of a broadcast company is provided in a particular number. Accordingly, even though a user does not change the display apparatus 100, in response to the user changing a broadcaster, the user may be provided with a set-top box and a remote controller from the broadcaster and the channel map, which is illustrated in FIG. 5.

The server 200 may store a plurality of channel maps which are different according to a broadcaster or a manufacture, and the channel maps may be updated by a predetermined cycle or may be updated frequently when the channel map is changed.

The server 200 detects a control code set corresponding to matching information which is received. That is, the server 200 may detect a channel map including the received matching information from the plurality of channel map, and determine a broadcaster or a manufacturer of the display apparatus 100.

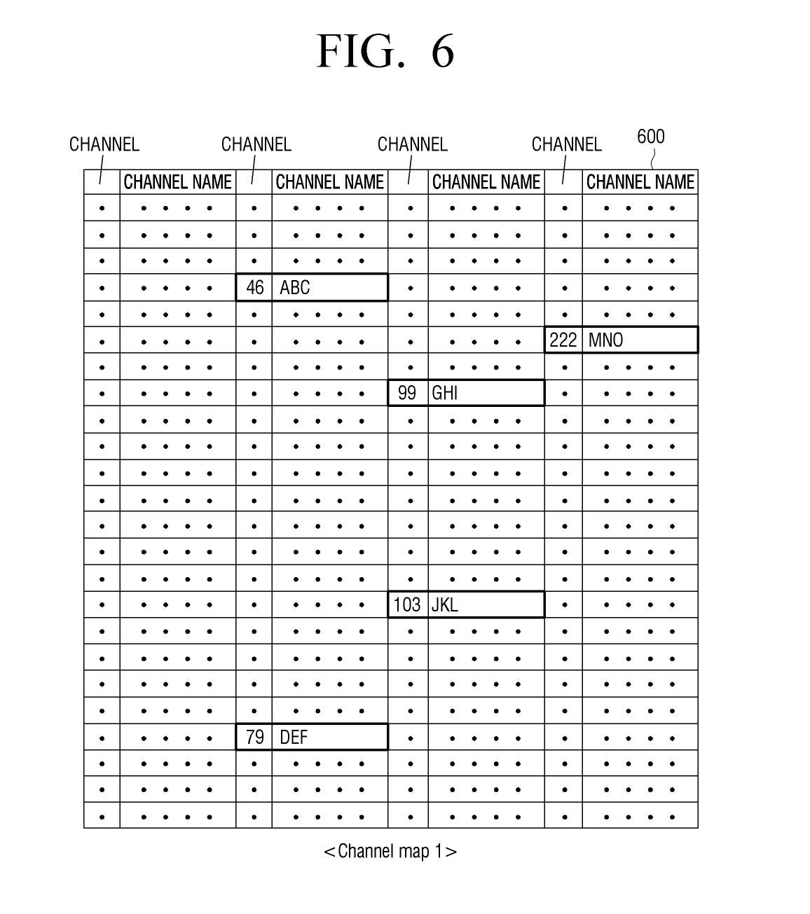

For example, the controller 130 may determine, based on the feature information of contents and the channel number information that a broadcasting company of a content provided on broadcasting channel number 46 is ABC broadcasting company, a broadcasting company of a content provided on broadcasting channel number 79 is DEF broadcasting company, a broadcasting company of a content provided on broadcasting channel number 99 is GHI broadcasting company, a broadcasting company of a content provided on broadcasting channel number 103 is JKL broadcasting company, and a broadcasting company of a content provided on broadcasting channel number 222 is MNO broadcasting company, as illustrated in FIG. 6, the server 200 may determine that a set-top box and a remote controller provided by a broadcaster corresponding to a channel map 1 is used, and transmit a control code set corresponding to this determination.

The server 200 may transmit the control code set in response to a broadcaster or a manufacturer determining that a sufficient amount of matching information is received.

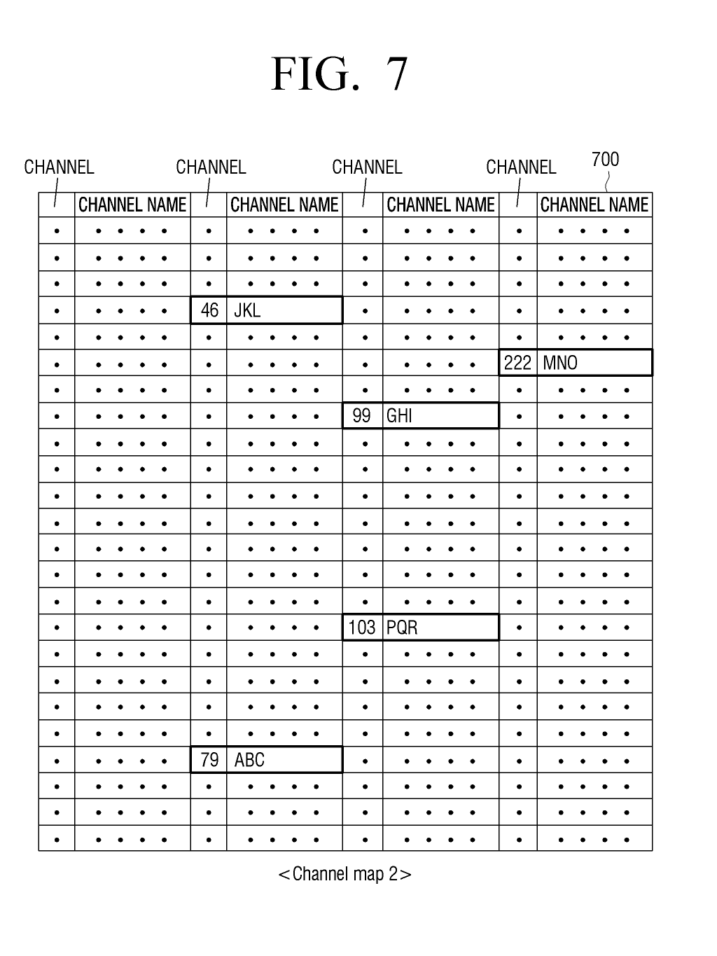

For example, the server 200 may determine a broadcaster who provides a content as a broadcaster corresponding to a channel map 1 as illustrated in FIG. 6 and a channel map 2 as illustrated in FIG. 7, at the same time in response to the matching information that a broadcasting company of a content provided on broadcast channel number 99 being GHI broadcasting company, and a broadcasting company of a content provided on broadcasting channel number 222 being MNO broadcasting company is received.

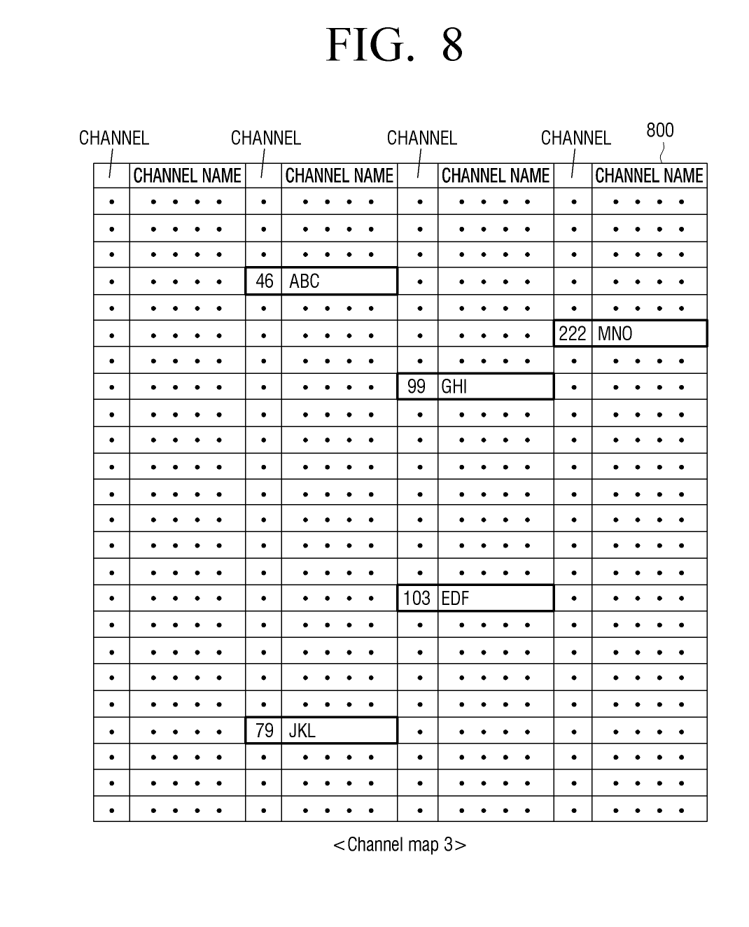

In a case where a broadcasting company of a content provided on broadcast channel number 46 is ABC broadcasting company, a broadcasting company of a content provided on broadcast channel number 99 is GHI broadcasting company, and a broadcasting company of a content provided on broadcast channel number 222 is MNO broadcasting company, the server 200 may determine a broadcaster who provides a content to the display apparatus 100 by a broadcaster corresponding to a channel map 1 illustrated in FIG. 6, a channel map 2 illustrated in FIG. 7, and a channel map 3 illustrated in FIG. 8, at the same time.

Accordingly, the server 200 may delay a choice of a control code set until the server decides the one broadcaster or one manufacturer.

The server 200 may transmit a plurality of control code sets to the controller 130 in response to a decision as to a predetermined number of broadcasters or manufacturers. Also, the controller 130 may be chosen by a user regarding which code set is proper from among the plurality of control code sets through the UI 300 for registering the control code set.

In response to the controller 130 receiving a control code set of a broadcaster which corresponds to particular information and a broadcast channel number information from the server 200 and provides the control code set to a universal remote controller through the UI 300 for registering the control code set, an information UI that the display apparatus 100 is able to set the universal remote controller, an information UI that the universal remote controller finishes setting, or an information UI that the use of the universal remote controller is available, may be displayed.

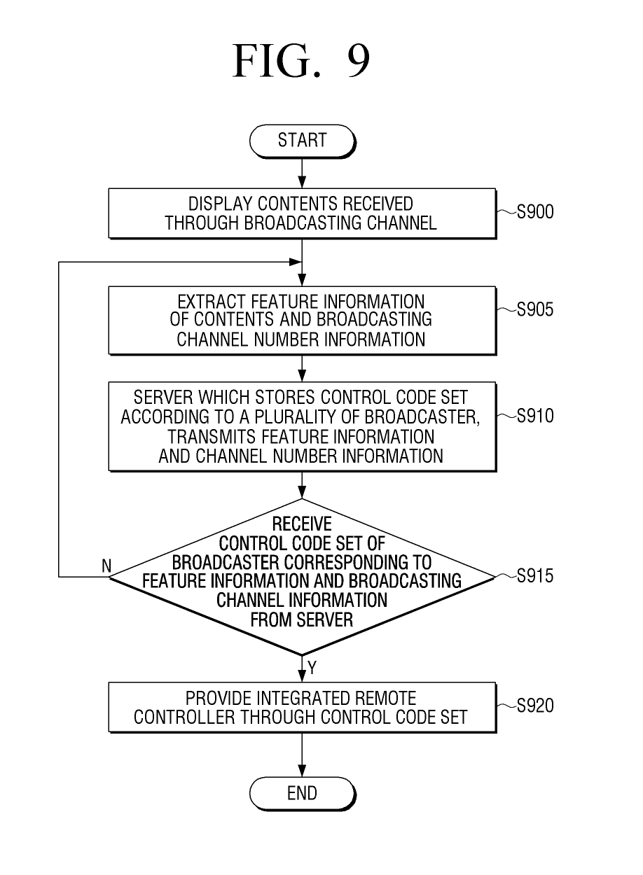

FIG. 9 is a flowchart to explain a method of setting a universal remote controller, according to an exemplary embodiment.

A content received through a broadcast channel is displayed S900 and the feature information of a content and the broadcast channel number information is extracted S905.

The broadcast channel number is a channel number of a broadcast that the display 110 displays, and the feature information of contents refers to a broadcasting company name, a program name, a program logo, an image of characters, a channel banner, a text, and so on, indicated in a content screen.

The feature information of contents refers to every kind of information which determines a broadcasting company which transmits a particular content. In particular, the feature information may be a broadcasting company logo indicated in a content screen, and the controller 130 may detect an image of an area where the broadcast logo is indicated from the content screen.

The server 200 which stores a control code set according to a plurality of broadcaster may transmit the feature information and the channel number information S910, and receive the control code set from the broadcaster which corresponds to the feature information and the broadcast channel number information from the server 200. The control code set may include button information regarding each button and signal information which occurs in response to each button is selected.

A remote controller for controlling the display apparatus 100 is different according to a broadcaster or a manufacturer of the display apparatus 100, and each button of the remote controller has a different output signal. Accordingly, the server 200 may store an output signal regarding each button of each remote controller as a control code set according to a broadcaster or a manufacturer. Also, the server 200 may frequently update the control code set frequently.

In response to the control code set not being received S915-Y, the extracted feature information and the channel number information may be transmitted again. The feature information and the channel number information may be different from the previously transmitted feature information and channel number information.

In response to the control code set being received S915-N, the control code set is provided to a universal remote controller S920. The universal remote controller may receive the control code set and control the display apparatus 100.

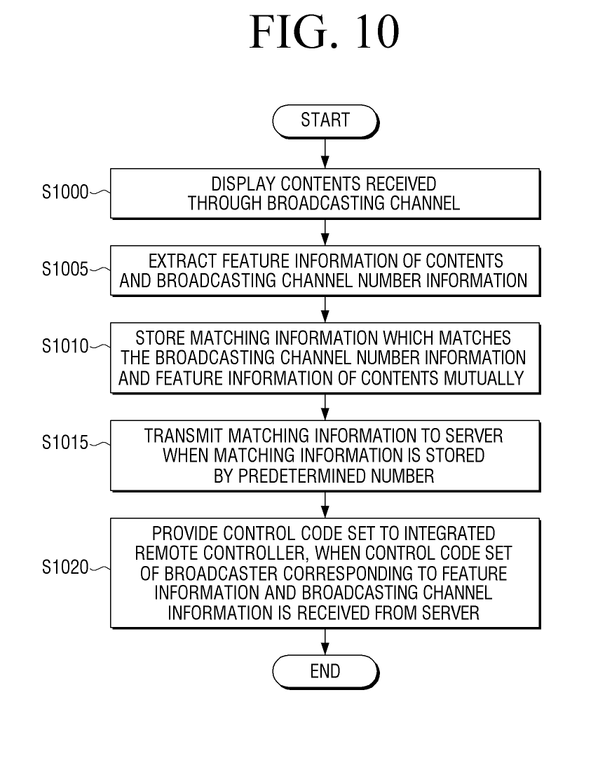

FIG. 10 is a flowchart to explain a method of setting a universal remote controller, according to an exemplary embodiment.

Contents received from a broadcast channel are displayed S1000, and the feature information of the contents and the broadcast channel number information are extracted S1005.

The broadcast channel number is a channel number of a broadcast that the display 110 displays, and the feature information of contents means a broadcast company name, a program name, a program logo, an image of characters, a channel banner, a text, and so on, indicated in a content screen.

The feature information of contents refers to every kind of information which is able to be determined regarding a broadcast company which transmits a corresponding content. Specifically, the feature information may be a broadcast company logo indicated in a content screen, and the controller 130 may extract an image of an area where the broadcast logo is indicated from the content screen, and recognize the broadcast company logo inside of the image.

The display apparatus 100 stores matching information which matches the broadcast channel number information and the feature information of contents mutually S1010. That is, the display apparatus 100 may store the broadcast channel information and the feature information of contents as the matching information according to a predetermined number. A number of the matching information may be difference from a setting of an early stage, and the number may be set by a user.

In response to the matching information being stored by a predetermined number, the stored matching information may be sent to the server S1015. A predetermined number of the matching information may be a sufficient amount of matching information to determine a broadcaster.

In response to a control code set of a broadcaster corresponding to the feature information and the broadcast channel number information being received from the server 200, the control code set is provided to a universal remote controller S1020.

The control code set may include button information regarding each button included in a universal remote controller, and signal information occurs in response to each button being selected.

A remote controller for controlling the display apparatus 100 is different according to a broadcaster or a manufacturer of the display apparatus 100, and each button of the remote controller has different output signals. Accordingly, the server 200 may store an output signal according to each button of each remote controller as a control code set according to a broadcaster or a manufacturer. Also, the server 200 may frequently update the control code set.

As above, according to various exemplary embodiments, in response to a user using various electronic apparatuses, especially when a broadcaster who provides contents to the display apparatus 100 changes, the user may set a universal remote controller by a previously provided remote controller through changing a plurality of channels without setting the universal remote controller channels one by one.

A method of setting the universal remote controller of the display apparatus according to various exemplary embodiments described above may be stored in a non-transitory readable medium after coding as software. The non-transitory readable medium may be used by loading in various apparatus

For example, a program code to perform displaying of contents received from a broadcast channel, extracting the feature information of contents and the broadcast channel number information, and transmitting the feature information and the broadcast channel number information to a server which stores a control code set according to a plurality of broadcaster may be provided by storing in the non-transitory readable medium. A method of processing energy conservation explained in a detailed description of exemplary embodiments may be coded as a program and stored in the non-transitory readable medium.

The non-transitory readable medium means a medium which stores a data semi-permanently and is readable by an apparatus, not a media which stores a data for a short period such as a register, a cache, a memory and so on. Specifically, a CD, a DVD, a hard disk, a Blu-ray Disc™, a USB, a memory card and ROM may be the non-transitory readable medium.

Desirable exemplary embodiments were illustrated and explained above, but are not limited to the described exemplary embodiments. Also, the description of the exemplary embodiments is intended to be illustrative, and not to limit the scope of the claims, and it would be appreciated by those skilled in the art that changes may be made to the embodiments without departing from the principles and spirit of the invention, the scope of which is defined in the appended claims.

1. A display apparatus, comprising:
a display configured to display contents received from a broadcast channel;
a communicator configured to perform communication with a server which is configured to store a control code set according to a plurality of broadcast providers; and
a controller configured to extract feature information related to the contents and broadcast channel number information, and transmit the information to the server through the communicator and provide the control code set to a universal remote controller in response to a control code set of a broadcast provider corresponding to the feature information and the broadcast channel number information being received from the server.

2. The display apparatus as claimed in claim 1, further comprising:
a storage configured to store matching information between the broadcast channel number information and the feature information of the contents,
wherein the controller is configured to transmit the matching information stored in the storage to the server in response to a predetermined number of matching information being stored.

3. The display apparatus as claimed in claim 1, wherein the server is implemented within the display apparatus.

4. The display apparatus as claimed in claim 1, wherein the controller is configured to display a User Interface (UI) to register the control code set in the universal remote controller on the display in response to the control code set being received from the server.

5. The display apparatus as claimed in claim 1, wherein the control code set comprises button information regarding each button included in the universal remote controller and signal information which occurs in response to each button being selected.

6. The display apparatus as claimed in claim 1, wherein the feature information includes a broadcasting company logo displayed on a content screen,
wherein the controller is configured to detect an image of an area where the broadcasting company logo is displayed from the content screen, and recognizes the broadcasting company logo in the image.

7. The display apparatus as claimed in claim 1, wherein the feature information of the contents includes at least one of a broadcasting company logo, a broadcasting company name, a program logo, an image of characters, a channel banner and a text displayed on a content screen.

8. A method of setting a universal remote controller of a display apparatus, the method comprising:
displaying contents received from a broadcast channel;
extracting the feature information of contents and information related to the channel number of the broadcast;
transmitting the feature information and broadcast channel number information to a server which stores a control code set according to the plurality of broadcast providers; and
providing the control code set to a universal remote controller in response to a control code set corresponding to the feature information and broadcast channel information being received from the server.

9. The method as claimed in claim 8, wherein the transmitting of the feature information and broadcast channel number information comprises:
storing matching information between the broadcast channel number information and the feature information related to the contents; and
sending the stored matching information to the server in response to the predetermined number of matching information being stored.

10. The method as claimed in claim 8, wherein the server is implemented within the display apparatus.

11. The method as claimed in claim 8, wherein providing the control code set to a universal remote controller further comprises displaying UI for registering the control code set in the universal remote controller in response to the control code set being received from the server.

12. The method as claimed in claim 8, wherein the control code set comprises, button information regarding each button included in the universal remote controller and signal information which occurs in response to each button being selected.

13. The method as claimed in claim 8, wherein the feature information comprises a broadcasting company logo displayed on the contents screen, and
wherein extracting the feature information includes detecting an image on an area where the broadcasting company logo is displayed from the contents screen and recognizing the broadcasting company logo on the image.

14. The method as claimed in claim 12, wherein the feature information of the contents includes one of a broadcasting company logo, a broadcasting company name, a program logo, an image of characters, a channel banner and a text displayed on a content screen.

15. A display apparatus, comprising:
a display configured to display contents received from a broadcast channel; and
a controller configured to extract feature information received from a broadcast channel which is related to contents and broadcast channel number information, and transmit the information to a server through a communicator and provide a control code set to a universal remote controller in response to a control code set of a broadcast provider corresponding to the received feature information and the broadcast channel number information.

16. The display apparatus of claim 15, wherein the control code set comprises button information regarding each button included in the universal remote controller and signal information which occurs in response to each button being selected.

17. The display apparatus of claim 15, further comprising a communicator configured to perform communication with a server which is configured to store a control code set according to a plurality of broadcast providers.

18. The display apparatus as claimed in claim 1, further comprising:
a storage configured to store matching information between the broadcast channel number information and the feature information related to the contents.

19. The display apparatus of claim 18, wherein the controller is configured to transmit the matching information stored in the storage to the server in response to a predetermined number of matching information being stored.

20. The display apparatus of claim 15, wherein the server is implemented within the display apparatus.
